(19) United States
(12) Patent Application Publication
(10) Pub. No.: US 2022/0398298 A1
(43) Pub. Date: Dec. 15, 2022

(54) SYSTEMS AND METHODS FOR SELECTIVE ACCESS OF A DIGITAL CONTENT

(71) Applicants: Raghav Arvindkumar Aggarwal, Mubai (IN); Abhinav Arvindkumar Aggarwal, Mubai (IN)

(72) Inventors: Raghav Arvindkumar Aggarwal, Mubai (IN); Abhinav Arvindkumar Aggarwal, Mubai (IN)

(21) Appl. No.: 17/777,276

(22) PCT Filed: Dec. 30, 2019
(86) PCT No.: PCT/IB2019/061430

§ 371 Date: May 16, 2022

(30) Foreign Application Priority Data
Nov. 15, 2019 (IN) 201921046752

(51) Int. Cl. G06F 21/10; G06F 16/583; H04L 12/28

(52) U.S. Cl. CPC G06F 21/10; G06F 16/583; H04L 12/2854

(57) ABSTRACT

An embodiment of the present disclosure provides a retrieving, by a computing device, a digital content pertaining to an event from a digital storage medium and storing the retrieved digital content in a secured repository. The computing device shares an access code of the secured repository with participants of the event in order to allow the participants to selectively access the secured repository. Responsive to receipt of a request through accessing the access code by at least one participant, the computing device receives an image of the at least one participant from a participant device and matches the received image with the digital content or part thereof to verify identity of the at least one participant. Further, responsive to verification of identity of the at least one participant, the computing device transmits a part of the digital content, pertaining to the at least one participant, to the participant device.

### TECHNICAL FIELD

The present invention relates generally to a digital content management. More particularly, systems and methods of the present disclosure facilitate selective access of digital content stored in a secured repository.

### BACKGROUND

In today's digital age, devices such as mobile phones or digital cameras are often used for taking photos and videos at a corporate or a social event. At such events, where there are a number of people attending, the number of photos taken can sometimes go up into hundreds or even thousands. These collections of photos, although immense, is exceptionally important to some people, particularly those associated closely with the event, such as the speakers and organizers at a corporate event, or the parents and close relatives of the bride and groom at a wedding event. However, even individuals who may not be associated closely but attended the event, do have an interest in viewing the photos from the event.

A person attending the event is particularly interested in looking at his or her own photos and videos along with those of his/her group of closely known people who attended the same event. To sort through those photos and provide relevant photos to relevant attendees becomes a tedious and time-consuming task. Additionally, there would be endless possible ways to customize the collection based on each attendee's preference of viewing these photos and videos. It becomes almost impossible to selectively sort the images and videos of each attendee from the entire event and send the sorted photos and videos to the relevant attendee. Thus, it is difficult to offer such customization to every individual.

The current technology provides two main options for viewing and sharing of photos. Either the owner of the album can sort through the photos manually or using an automated system, and then share the same set of images of his/her choice with everyone. In this case, everyone will be able to view a small subset of photos which may or may not have their photos and may not be relevant to them. The second option is for the album owner to upload and share the entire album containing thousands of photos and videos through a website or on a social media platform. This option allows everyone to access all the photos. However, the viewers still have to go through all the photos to search for their own photos or of their close ones, again making it a time-consuming task. Additionally, this method compromises the security of the photos, as anyone is able to view the photos of any other attendee at the event. It gives access to the entire album to everyone, maybe even those who were not a part of the event.

Hence, there arises the need to have a secure and customized option of viewing the digital content including images and videos as desired by the person viewing it. It is with respect to these considerations and others that the disclosure made herein is presented.

### OBJECTS OF THE PRESENT DISCLOSURE

Some of the objects of the present disclosure aimed to ameliorate one or more problems of the prior art or to at least provide a useful alternative are listed herein below.

An object of the present disclosure is to provide a system and method to facilitate selective access of digital content stored in a secured repository.

Another object of the present disclosure is to provide a system and method to facilitate selective access of digital content, wherein all the digital images and videos of an event are collectively grouped into an event album.

Another object of the present disclosure is to provide a system and method to facilitate selective access of digital content wherein a link of an uploaded event album is made available to any person who may want to view the event album.

Another object of the present disclosure is to provide a system and method that enhances security of the album.

Another object of the present disclosure is to provide a system and method to facilitate access of the album exclusively to participants having access to the link of the uploaded event album.

Another object of the present disclosure is to provide a system and method that facilitates maintaining the security of the album by demanding details of the participants accessing link of the uploaded event album and the demanded details are at least one of e-mail, name of the participant, mobile number of the participant, and the like.

Another object of the present disclosure is to provide a system and method for selective access of digital content, where the participant instead of manually searching, may set his or her requirements to view the images or videos of one or more individuals.

Another object of the present disclosure is to provide a system and method for selective access of digital content, wherein the participant can upload his own real time captured image or upload an image from the participant device and the system identifies matching images to the uploaded image using facial recognition techniques.

Another object of the present disclosure is to provide a system and method for selective access of digital content, where the participant may set preferences to view the images or videos of one or more individuals separately or all of them in a group.

### SUMMARY OF THE INVENTION

The present invention relates generally to a digital content management. More particularly, systems and methods of the present disclosure facilitate selective access of digital content stored in a secured repository.

According to an aspect of the present disclosure, a system comprises a processor and memory coupled to the processor and storing instructions that, when executed by the processor, cause the system to perform operations comprising: retrieving a digital content comprising any or a combination of image content and video content pertaining to an event from a digital storage medium and storing the retrieved digital content in a secured repository; sharing an access code of the secured repository with a plurality of participants of the event in order to allow one or more participants of the plurality of participants to selectively access the secured repository; responsive to the receipt of a request through accessing the access code by at least one participant of the one or more participants, receiving an image of the at least one participant from a participant device and matching the received image with the digital content or part thereof to verify identity of the at least one participant; and responsive to the verification of identity of the at least one participant, transmitting a part of the digital content to the participant device, wherein the said part of the digital content pertains to the at least one participant.

According to an embodiment, the system facilitates using a facial recognition technique to identify matching images from the digital content, to the received images of the at least one participant, wherein the received images pertains to the at least one participant's face.

According to an embodiment, the system facilitates transmitting the matching part of the digital content to the participant device, wherein the said part of the digital content pertains to the at least one participant and contains the same facial features as those in the image uploaded by the participant.

According to an embodiment, the system facilitates the at least one participant to select viewing of the part of the digital content transmitted to the at least one participant device, and wherein said viewing comprises viewing any or a combination of the part of the digital content pertaining only to the at least one participant and the part of the digital content pertaining to the at least one participant with the one or more participants in a group.

According to an embodiment, the access code is shared in form of any or a combination of a uniform resource locator (URL), a bar code, a QR code and an alpha numeric code.

According to an embodiment, the access code is shared via any or a combination of a text message, an email, a social media message and a multimedia message.

According to an embodiment, the image of the at least one participant is a real-time image captured using a camera on the participant device and uploaded by the participant onto the system for identity verification.

According to an embodiment, the image of the at least one participant is selected from a plurality of images or videos stored in the participant device and uploaded by the participant onto the system for identity verification.

According to an embodiment, multiple participants can together share an image of all such participants to retrieve all digital content where at least one part of each participant is present in the displayed digital content and then select to view all digital content where all such multiple participants are present together in each image of the displayed digital content.

According to an embodiment, the system facilitates the participant to set preferences to view any combination of displayed images.

According to an embodiment, the system monitors the part of the digital content being viewed at the participant device.

According to an embodiment, the system maintains a log of attributes of the participant who views the part of the digital content.

According to an embodiment, the system receives a notification when the plurality of images and videos are received for storage in the secured repository.

According to an embodiment, the secured repository is controlled by an administrator using an administrator device.

According to another aspect, a method comprises retrieving, by a computing device, a digital content comprising any or a combination of image content and video content pertaining to an event from a digital storage medium and storing the retrieved digital content in a secured repository; sharing, by the computing device, an access code of the secured repository with a plurality of participants of the event in order to allow one or more participants of the plurality of participants to selectively access the secured repository; responsive to the receipt of a request through accessing the access code by at least one participant of the one or more participants, receiving, by the computing device, an image of the at least one participant from a participant device and matching the received image with the digital content or part thereof to verify identity of the at least one participant; and responsive to the verification of identity of the at least one participant, transmitting a part of the digital content to the participant device, wherein the said part of the digital content pertains to the at least one participant.

Various objects, features, aspects and advantages of the present disclosure will become more apparent from the following detailed description of preferred embodiments, along with the accompanying drawing figures in which like numerals represent like features.

### BRIEF DESCRIPTION OF THE ACCOMPANYING DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates a network implementation of a system, which facilitates selective access of digital content stored in a secured repository in accordance with an embodiment of the present disclosure.

FIG. 2 illustrates exemplary functional components of the system in accordance with an embodiment of the present disclosure.

FIGS. 3A-D illustrate exemplary representations of a user device to selectively access digital content in accordance with an embodiment of the present disclosure.

FIG. 4A is a flow diagram illustrating process performed at the system through an administrator device in accordance with an embodiment of the present disclosure.

FIG. 4B is a flow diagram illustrating working of a participant device in accordance with an embodiment of the present disclosure.

FIG. 5 is a high-level flow diagram illustrating working of the system in accordance with an embodiment of the present disclosure.

FIG. 6 illustrates an exemplary computer system to implement the proposed system in accordance with embodiments of the present disclosure.

### DETAILED DESCRIPTION

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this invention will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claim.

In the context of the specification, the term “event album” refers to a collection of series of digital content that includes digital images and videos of a particular event which are captured using one of more devices such as mobile phones, digital cameras, video cameras or any other device which can capture images and videos digitally.

In the context of the specification, the term “album creator” (also referred to herein as “administrator”) refers to a user who uploads all the collection of series of digital images and videos of a particular event onto an online platform through a computing device such as desktops, mobile phones, laptops.

In the context of the specification, the term “album viewer” (also referred to herein as “participant”) refers to a user who views the collection of series of digital images and videos of the event album on a computing device such as mobile phones, tablets, laptops, desktops.

In the context of the specification, the term “live photo” refers to taking a real time picture of the user using image capturing devices such as mobile phones, in-built web camera of a laptop or externally attached web camera to a computer.

In the context of the specification, the term “individual” refers to one or more users who were a part of the event or are using the platform for viewing photos and videos from the event.

The present invention relates generally to digital content management. More particularly, systems and methods of the present disclosure facilitate selective access of digital content stored in a secured repository.

According to an aspect of the present disclosure, a system comprises a processor and memory coupled to the processor and storing instructions that, when executed by the processor, cause the system to perform operations comprising: retrieving a digital content comprising any or a combination of image content and video content pertaining to an event from a digital storage medium and storing the said retrieved digital content in a secured repository; sharing an access code of the secured repository with a plurality of participants of the event in order to allow one or more participants of the plurality of participants to selectively access the secured repository; responsive to the receipt of a request through accessing the access code by at least one participant of the one or more participants, receiving an image of the at least one participant from a participant device and matching the received image with the digital content or part thereof to verify identity of the at least one participant; and responsive to the verification of identity of the at least one participant, transmitting a part of the digital content to the participant device, wherein the said part of the digital content pertains to the at least one participant.

According to an embodiment, the system facilitates using a facial recognition technique to identify matching images to the received images of the at least one participant, wherein the received images pertains to the at least one participant's face, from the digital content.

According to an embodiment, the system facilitates transmitting the matching part of the digital content to the participant device, wherein the said part of the digital content pertains to the at least one participant and contains the same facial features as those in the image uploaded by the participant.

According to an embodiment, the system facilitates the at least one participant to select viewing of the part of the digital content transmitted to the at least one participant device, and wherein said viewing comprises viewing any or a combination of the part of the digital content pertaining only to the at least one participant and the part of the digital content pertaining to the at least one participant with the one or more participants in a group.

According to an embodiment, the access code is shared in form of any or a combination of a uniform resource locator (URL), a bar code, a QR code and an alpha numeric code.

According to an embodiment, the access code is shared via any or a combination of a text message, an email, a social media message and a multimedia message.

According to an embodiment, the image of the at least one participant is a real-time image captured using the camera on the participant device and uploaded by the participant onto the system for identity verification.

According to an embodiment, the image of the at least one participant is selected from a plurality of images or videos stored in the participant device and uploaded by the participant onto the system for identity verification.

According to an embodiment, multiple participants can together share an image of all such multiple participants to retrieve all digital content where at least one part of each participant is present in the displayed digital content and then select to view all digital content where all such multiple participants are present together in each image of the displayed digital content.

According to an embodiment, the system facilitates the participant to set preferences to view any combination of displayed images.

According to an embodiment, the system monitors the part of the digital content being viewed at the participant device.

According to an embodiment, the system maintains a log of attributes of the participant who views the part of the digital content.

According to an embodiment, the system receives a notification when the plurality of images and videos are received for storage in the secured repository.

According to an embodiment, the secured repository is controlled by an administrator using an administrator device.

According to another aspect, a method comprises retrieving, by a computing device, a digital content comprising any or a combination of image content and video content pertaining to an event from a digital storage medium and storing the said retrieved digital content in a secured repository; sharing, by the computing device, an access code of the secured repository with a plurality of participants of the event in order to allow one or more participants of the plurality of participants to selectively access the secured repository; responsive to the receipt of a request through accessing the access code by at least one participant of the one or more participants, receiving, by the computing device, an image of the at least one participant from a participant deviceand matching the received image with the digital content or part thereof to verify identity of the at least one participant; and responsive to the verification of identity of the at least one participant, transmitting a part of the digital content to the participant device, wherein the said part of the digital content pertains to the at least one participant.

Referring to the drawings, the invention will now be described in more detail.

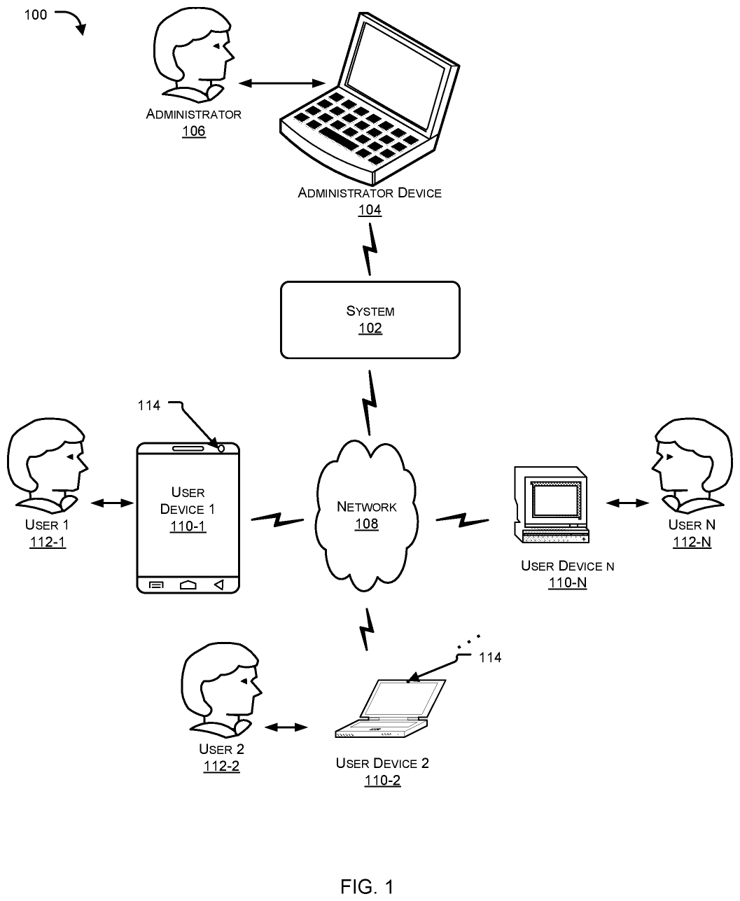

FIG. 1 illustrates a network implementation 100 of a system 102, which facilitates selective access of digital content stored in a secured repository in accordance with an embodiment of the present disclosure.

According to an embodiment, a system 102 implemented in any computing device can be configured/operatively connected with an administrator device 104 being operated by an administrator 106. Further, multiple users 112-1, 112-2 . . . 112-N (which are collectively referred to as users 112 and individually referred to as the user 112, hereinafter) can communicate with the system 102 through one or more user devices 110-1, 110-2 . . . 110-N (which are collectively referred to as user devices 110 and individually referred to as the user device 110, hereinafter) that can be communicatively coupled to the system 102 through a network 108. The users 112 can be any person, who is a participant of an event such as a sports event, a corporate event, a wedding event or any other suitable gathering of people. The administrator device 104 and the user devices 110 can include a variety of computing systems, including but not limited to, a laptop computer, a desktop computer, a notebook, a workstation, a portable computer, a personal digital assistant, a handheld device, a smartphone and a mobile device. It has to be appreciated that as users 112 are participants of an event, therefore users 112 are interchangeably referred to as participants 112 and user devices 110 are interchangeably referred to as participant devices hereinafter.

Further, the network 108 can be a wireless network, a wired network or a combination thereof. The network 108 can be implemented as one of the different types of networks, such as intranet, local area network (LAN), wide area network (WAN), the internet, Wi-Fi, LTE network, CDMA network, and the like. Further, the network 108 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 108 can include a variety of network devices, including routers, bridges, servers, computing devices, storage devices, and the like.

According to an aspect, the system 102 can retrieve a digital content including any or a combination of image content and video content pertaining to an event from a digital storage medium so that the retrieved digital content can be stored in a secured repository, which can be controlled by the administrator 106 using the administrator device 104. For example, system 102 can be utilized for event album management, where digital content including images and videos of an event can be uploaded onto an online secured repository through the administrator device 104 by the administrator 106, who can be an album creator of an event album. The administrator 106 or album creator can create an account on the system 102 to manage tasks including, but not limited to, uploading of the event albums, securing the event album links, getting notifications about album viewers, and the like.

According to an aspect, the system 102 can send an access code of the secured repository to the participants 112 via a text message, an email, a social media message, a multimedia message, and the like. The access code can be in form of any or a combination of a URL, a bar code, a QR code, an alpha numeric code and the like, which can allow the participants 112 to selectively access the secured repository. For example, the administrator 106 can create a link of the event album and can share the link via an email or can upload the link on a website such as social networking site. Further the administrator device 104 can secure the link before sharing it.

According to an aspect, when the participant 112 accesses the access code, the system 102 can receive one or more images corresponding to one or more participants 112 from a participant device 110 such that the received images can be matched with the digital content or part thereof to verify identity of the participants. In an implementation, the images of the participants 112 can be selected from a real-time captured image of the participant using a camera 114 on the participant device 110. In another implementation, the images of the participants 112 can be selected from a plurality of images or videos stored in the participant device 110. For example, the participant 112 or album viewer can click on the link shared by the administrator 106 and can upload the captured real-time photo or an existing one or more images of himself/herself.

Further, one or camera can be operatively coupled with the participant device 110, such as a desktop computer. The camera can capture the real time photo of the participant 112 or the album viewer and the said real-time captured photo can be uploaded by the participant 112 in the secured repository.

Further, when identity of the participants 112 is verified, the system 102 can transmit a part of the digital content to the participant device 112, where the part pertains to the digital content corresponding to the participants 112, based on facial recognition and matching of the faces in the uploaded images with the faces in the digital content. Therefore, upon identification of the uploaded images, the system 102 can display plurality of images of the album viewer from the event album. The system 102 monitors the part of the digital content, which is being viewed at the participant device 110 and also maintains a log of attributes of the participant who views the part of the digital content such as name, e-mail address, mobile number and the like.

In one implementation, the album viewer or the participant 112 can upload any or a combination of real-time or stored images of himself/herself along with images of other participants 112. Further, the system 102, upon identification of the uploaded images, can identify the participants 112 and can display a plurality of images and/or videos in which one of more of the participants 112 are present. Further, the administrator 106 can be notified about who views the images or videos and which images or videos are being viewed.

Those skilled in the art would appreciate that a display device can be a prebuilt component of the user device 110, which enables viewing of the photos or videos by the participant 112. However, the display device can also be the component of other prebuilt devices like a laptop, an LCD screen, an LED screen, etc. coupled with the user device 110.

According to an embodiment, the plurality of images and videos pertaining to the event, which are displayed on the participant device, can be downloaded for storage onto the participant device. The system 102 can receive a notification when any image and video is downloaded for storage on the participant device. Therefore, the administrator may be notified about which images or live photos were uploaded by the album viewer and which photos or videos from the secured repository were downloaded by the album viewer onto the participant device. It has to be appreciated that the secured repository can be controlled by the administrator 106 using the administrator device 104.

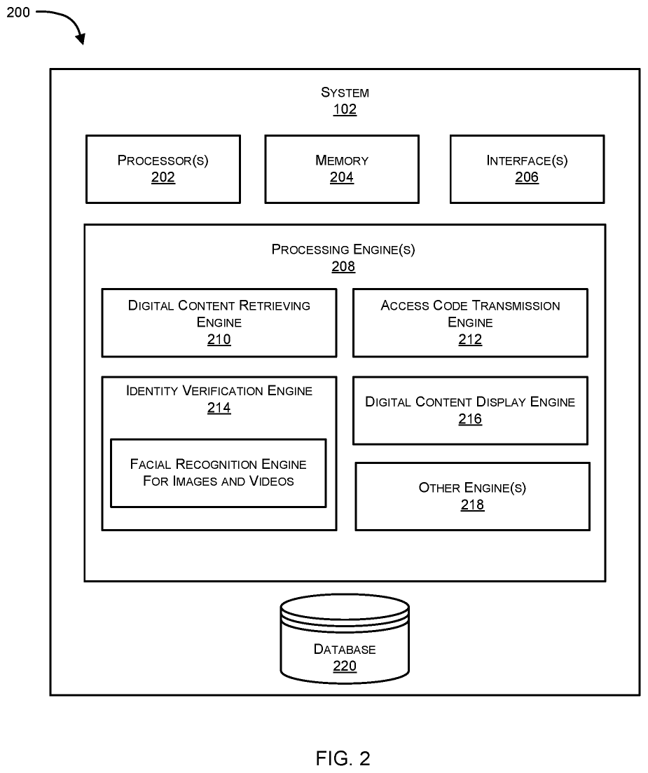

FIG. 2 illustrates exemplary functional components of the system 102 in accordance with an embodiment of the present disclosure.

In an aspect, the system 102 may comprise one or more processor(s) 202. The one or more processor(s) 202 may be implemented as one or more microprocessors, microcomputers, microcontrollers, digital signal processors, central processing units, logic circuitries, and/or any devices that manipulate data based on operational instructions. Among other capabilities, the one or more processor(s) 202 are configured to fetch and execute computer-readable instructions stored in a memory 204 of the system 102. The memory 204 may store one or more computer-readable instructions or routines, which may be fetched and executed to create or share the data units over a network service. The memory 204 may comprise any non-transitory storage device including, for example, volatile memory such as RAM, or non-volatile memory such as EPROM, flash memory, and the like.

The system 102 may also comprise an interface(s) 206. The interface(s) 206 may comprise a variety of interfaces, for example, interfaces for data input and output devices, referred to as I/O devices, storage devices, and the like. The interface(s) 206 may facilitate communication of system 102. The interface(s) 206 may also provide a communication pathway for one or more components of the processing engine 208. Examples of such components include, but are not limited to, processing engine(s) 208 and database 220.

The processing engine(s) 208 may be implemented as a combination of hardware and programming (for example, programmable instructions) to implement one or more functionalities of the processing engine(s) 208. The processing engine(s) 208 is stored on the memory 204 and runs on the processor(s) 202. In examples described herein, such combinations of hardware and programming may be implemented in several different ways. For example, the programming for the processing engine(s) 208 may be processor executable instructions stored on a non-transitory machine-readable storage medium and the hardware for the processing engine(s) 208 may comprise a processing resource (for example, one or more processors), to execute such instructions. In the present examples, the machine-readable storage medium may store instructions that, when executed by the processing resource, implement the processing engine(s) 208. In such examples, the system 102 may comprise the machine-readable storage medium storing the instructions and the processing resource to execute the instructions, or the machine-readable storage medium may be separate but accessible to system 102 and the processing resource. In other examples, the processing engine(s) 208 may be implemented by electronic circuitry.

The database 220 may comprise data that is either stored or generated as a result of functionalities implemented by any of the components of the processing engine(s) 208 or the system 102. In an embodiment, the processing engine(s) 208 may include a digital content retrieving engine 210, an access code transmission engine 212, an identity verification engine 214, a digital content display engine 216 and other engine (s) 218. Other engine(s) 218 can supplement the functionalities of the processing engine 208 or the system 102.

According to an embodiment, the digital content retrieving engine 210 can retrieve a digital content including any or a combination of image content and video content pertaining to an event from a digital storage medium for storage in a secured repository. In an implementation, the digital content retrieving engine 210 can retrieve digital content including images and videos of an event for storage in an online secured repository, for example, an event album can be created by retrieving the digital content of the event.

According to an embodiment, the access code transmission engine 212, can create an access code of the secured repository in form of a URL, a bar code, a QR code, an alpha numeric code and the like and can send an access code to participants of the event via a text message, a chat box message, an email, a social media message, a multimedia message, and the like. The access code can allow the participants 112 to selectively access the secured repository. For example, the access code transmission engine 212 can create a link of the event album and can share the link via an email or can upload on a website such as the company website or a social networking site. Further, the access code transmission engine 212 can also secure, say for example using an encryption key, the link before sending to the participants.

According to an embodiment, the participant can access the received access code such that when the identity verification engine 214 receives a notification that the participant has accessed the code, the identity verification engine 214 can receive images corresponding to the participants from the participant device such that the received images can be matched with the digital content or part thereof to verify identity of the participants. In an implementation, the images of the participants can be selected from a plurality of images or videos stored in the participant device or can be captured in real-time using a camera from the participant device.

According to an embodiment, the identity verification engine 214 further facilitates providing facial recognition for the participants. The facial recognition can be done for the received images and videos of the participants from the participant device. The received images corresponding to the participants can be received from the participant device and the facial recognition facilitates identifying matching images containing the said participant's face from the digital content. Further, the facial recognition facilitates identifying matching videos containing the said participant's face from the digital content.

According to an embodiment, when identity of the participants is verified, the digital content display engine 216 can determine a part of the digital content that pertains to the participants such that on successful verification, the part can be transmitted to the participant device for display. Thus, only verified participants can view the images/videos of the digital content. Further only images and videos pertaining to the said participant will be retrieved from the digital content and displayed on the participant device.

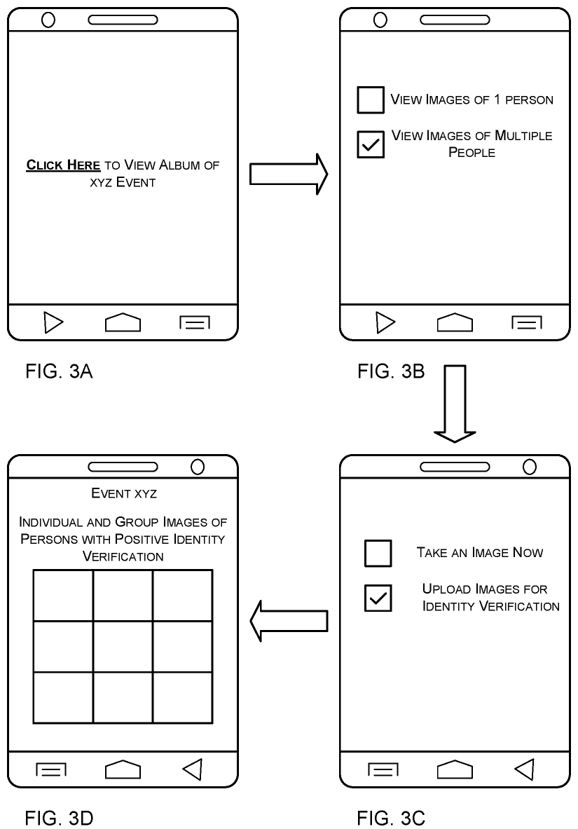

FIGS. 3A-D illustrate exemplary representations of a user device to selectively access digital content in accordance with an embodiment of the present disclosure.

As an example, FIGS. 3A-D provide exemplary representations for a participant or an album viewer to selectively view his/her own images along with images of few other participants from a secured repository of an event album. The participant device can be connected to a network, which is connected to the system. As illustrated in FIG. 3A, the participant device can receive a link containing access code of the album from the system. On clicking the link, a request can be raised to the system to view images of the album. As illustrated in FIG. 3B, the participant can be provided with two options. Option one can be indicative of viewing images of the participant alone and option two can be indicative of viewing images of the participant along with one or more individuals who were part of the event. The participant may select one or more of the options and based on the option selected by the participant, as illustrated in FIG. 3C, the participant can upload one or more images for verification. On successful verification of the images by matching of the faces in the uploaded images with those of the faces in the event album, as illustrated in FIG. 3D, the system can then identify and display all the images of the participants and other individuals on the display device. It should be appreciated that a number of selection options, apart from the ones in the FIG. 3B, may be available to the participant. The participant may select to view images which have only the participant, or view all images which have the participant as a part of a group with other individuals at the event. The participant may upload images of the participant as well as another individual, and select to view all images which have both the participant and the said individual, or select to view images which have either the participant or the said individual. Other viewing options such as two or more individuals as a part of a larger group image may also be made displayed on the participant device.

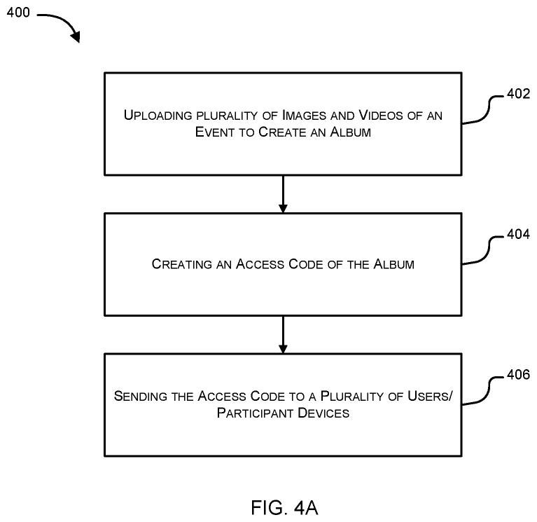

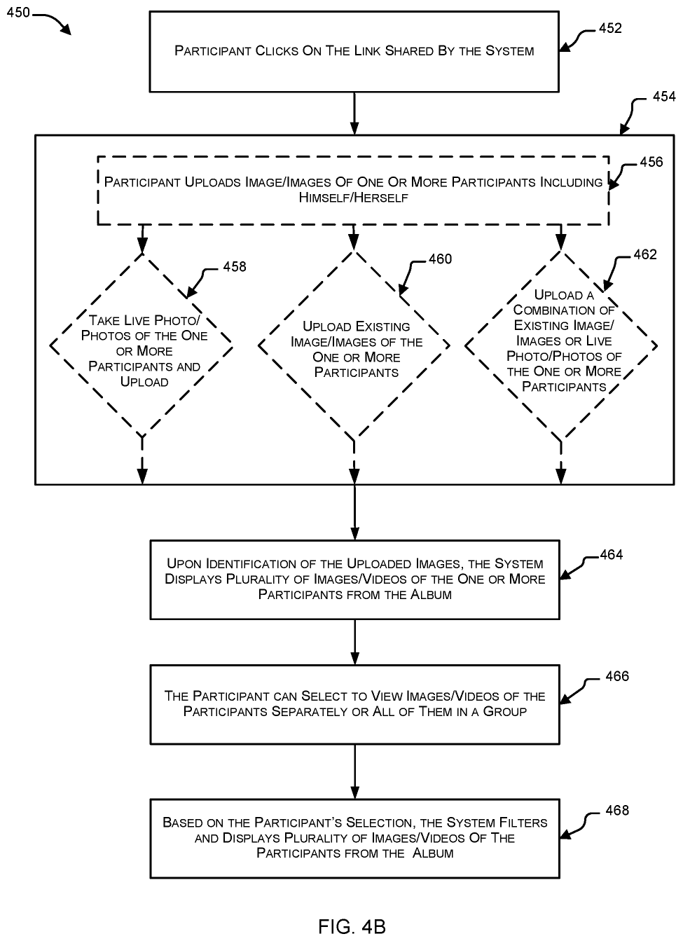

FIG. 4A is a flow diagram 400 illustrating process performed at the system through an administrator device in accordance with an embodiment of the present disclosure.

In context of the present example, the method begins at step 402, where the system retrieves plurality of images and videos of an event to create an album. For example, the system can retrieve images uploaded by an administrator on the administrator device. At step 404, the system can create a link or an access code for the event album and can optionally secure the link. Therefore, those skilled in the art would appreciate that embodiments of the present disclosure can be used for event album management, where all the digital images and videos of the event can be made available to participants of the event. With a view to provide security of data, the administrator can provide access of the link and then at step 406, the system can share the link with the participants.

In an embodiment, when the participant accesses the link, the secure link can demand details of the participant, which can include at least one of e-mail, name of the participant, mobile number of the participant, and the like.

Another way to secure the link and ensure that the participant can only see his/her own photos can be to allow only a live/real-time photo to be uploaded onto the system by the participant. In such a scenario, the participant cannot upload any pre-existing images of himself/herself or of any other individual. Uploading of the real-time photo can ensure that only the individual using the album link is able to see his/her own photos.

FIG. 4B is a flow diagram 450 illustrating working of a participant device in accordance with an embodiment of the present disclosure.

In context of the present example, a method for uploading an image by a participant along with one or more images of one or more participants and display of plurality of images/videos of the participants from the album based on participant's selection includes, at step 452, clicking by the participant on the link shared by the system on the participant device. At step 454, the participant can upload one or more images of one or more participants. At step 456, the participant may follow three scenarios for selectively uploading the images:

Scenario 1: At step 458, the participant can take one or more live photos of the one or more participants along with live photo of the participant himself/herself, with the help of the camera on the participant device and upload them.

Scenario 2: At step 460, the participant can upload existing one or more photos of the one or more participants along with the existing photo of the participant himself/herself, which are already stored in the participant device.

Scenario 3: At step 462, the participant can upload a combination of one or more existing photos and one or more live photos of the one or more participants along with the existing photo or live photo of participant himself/herself.

Further, based on the image/video uploaded by the participant, at step 454, in step 464 the system can identify the uploaded images and display plurality of images of the one or more participants along with the participant, based on facial recognition, from the album created at step 402. Further, the system also displays the plurality of videos of which the one or more participants were part of, along with the participant, from the album.

At step 466, the participant can further have an option of selectively viewing the plurality of images or videos of the one or more participants, whose images were uploaded in step 454, separately and/or in any combination with each other and/or in a group with other participants. Based on participant's selection at step 466, at step 468 the system further filters and displays the plurality of images or videos of the one or more participants, from the album.

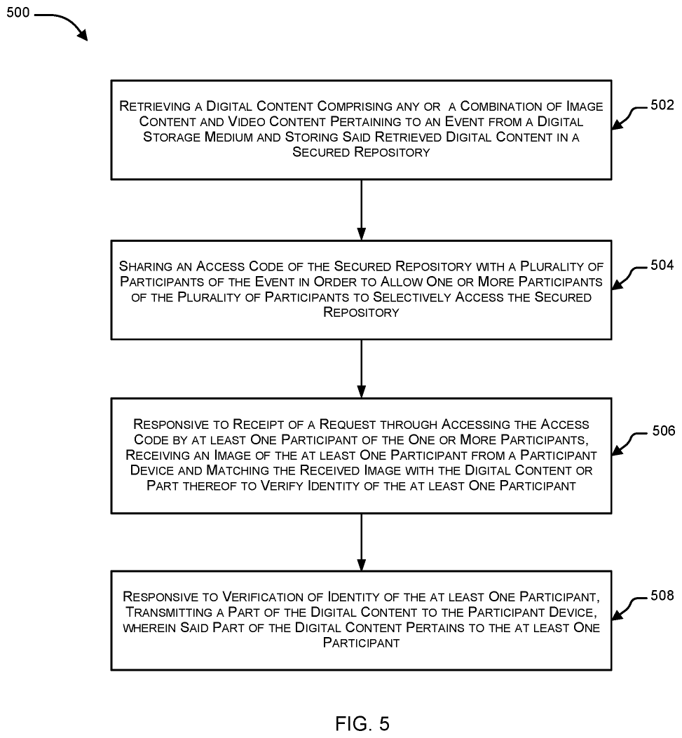

FIG. 5 is a high-level flow diagram 500 illustrating working of the system in accordance with an embodiment of the present disclosure.

In context of the present example, at block 502, a computing device implementing the system, can retrieve a digital content comprising any or a combination of image content and video content pertaining to an event from a digital storage medium and can store the retrieved digital content in a secured repository. Further, at step 504, the system can share an access code of the secured repository with a plurality of participants of the event in order to allow one or more participants of the plurality of participants to selectively access the secured repository.

In response to receipt of a request through accessing the access code by at least one participant of the one or more participants, at block 506, the computing device an receive an image of the at least one participant from a participant device and match the received image with the digital content or part thereof to verify identity of the at least one participant. Furthermore, when identity of the at least one participant is verified, at block 508, the computing device can transmit a part of the digital content to the participant device, where the part of the digital content pertains to the at least one participant.

In yet another embodiment, the administrator can receive notifications in form of e-mail, chat notification or SMS and the notifications can include the content which the participant is viewing and the images/videos which are being viewed from the event album Furthermore, the administrator can be notified which images/videos have been uploaded by the participant.

Various embodiments of the present disclosure can be implemented for notifying an administrator. According to an embodiment, the administrator can receive notification, through an e-mail, or an app or on logging onto the system, on who views the images/videos and which images/videos are being viewed. The notification may be in the form of e-mail, SMS, chat notification and may include contents like the name of the participant who views the album along with details of the participant including, but not limited to, e-mail and mobile number along with time-stamp at which the participant viewed the album. The administrator can also receive notifications, regarding the images, which the participant uploaded for viewing the event album.

Further, according to an embodiment, the administrator can create an account on the system for managing of the account and performing thetasks including, but not limited to, uploading of the event albums, securing the event album links, getting notifications about the album viewers, and the like.

An exemplary implementation of various embodiments of the present disclosure thereof can be further explained with the help of an example. According to the example, following steps may be performed:

At step 1, an administrator, which can be an album creator, can create an event album including plurality of images and videos of a wedding event on a computing device. The event album can comprise images and videos of the bride and the groom along with the guests who attended the wedding.

At step 2, the album creator can create a link of the event album and optionally can secure the link by demanding the captured live photo of the participant or by demanding the details of the participant, which can include at least one of e-mail, name of the participant, mobile number of the participant, and the like. Further, the album creator can upload and share the link by an email, messaging application or by uploading the link on a website or by using a social media platform.

At step 3, a participant or an album viewer can click on the link, which he has received from the album creator. Since the administrator has created a secure link, the participant needs to enter at least one of his personal details such as but not limited to the e-mail, name of the participant or mobile number of the participant, and the real-time image of himself. Further, on successful verification of the participant, by comparing his facial features from the image uploaded by the participant and matching them with the faces in images from the event album, the system can identify and display all the images of the participant, either alone or with his friends in a group, from the event album, on the participant's device. The participant can further select to view the images where the images can be individual images of the participant or of a group containing the participant along with the other participants.

At step 4, the album viewer may choose to view videos from the event album by clicking on the link shared by the album creator and can capture and upload live photo of himself using the camera on his device. On successful verification of the participant that is done by comparing his facial features from the image uploaded by the participant and matching them with the faces in videos from the event album, the system can identify and display all the videos of the participant, either alone or with his friends in a group from the event album, on the participant device. The participant can then select to view the videos which have only him and/or the videos in which he is present along with other participants.

At step 5, the album viewer can choose to view the images or videos from the event album along with images and videos of one or more individuals who had attended the wedding event. For example, the album viewer may choose to view his images and videos along with those of his mother. Thus, the album viewer may capture live photo of himself and live photo of his mother separately and upload them or can capture and upload live photo of both of them together. On successful verification of the participant and his mother, by comparing the facial features of the participant and his mother from the image uploaded by the participant along with his mother and matching them with the faces in images from the event album, the system can identify and display all the images and videos of the participant along with his mother.

At step 6, the album viewer can further select to filter the images and videos displayed and select to view the images and videos of him with his mother separately and/or in any combination with each other and/or in a group with other participants. Thus, based on this further selection of the album viewer, the images and videos from the event album can be displayed.

At Step 7, to provide security, the album creator can get notification of who has viewed the event album and which images and videos of the event album were viewed. Also, the album creator can be notified of which images were uploaded by the album viewer to view the event album.

Those skilled in the art would appreciate that in view of above-mentioned embodiments, the present invention provides a number of technical advantages. For example, the system and method of present disclosure attains a goal to provide one click access to an event album, to all those who were a part of the event, simultaneously and a goal of replacing time consuming and tedious process of filtering and sorting of images individually and further sending the same to every person who attended the event.

The present disclosure also provides a platform for customized viewing of the event album without having the need to manually filter the images and videos of the event album and enables secured viewing of the event album, wherein the access to the event album is possible only to those who have the access to the link of the event album.

Techniques disclosed herein allow viewing only a part of the event album in which the album viewer was a part and notifying the album creator about who has viewed the event album and which images and videos were viewed. Thereby, allowing effective monitoring and control of viewing of the event album.

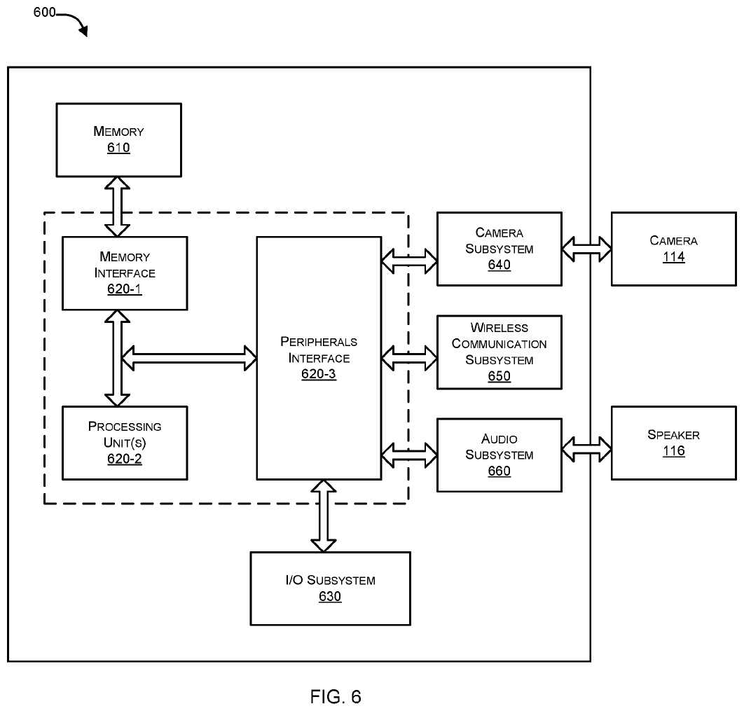

FIG. 6 illustrates an exemplary computer system 600 to implement the proposed system in accordance with embodiments of the present disclosure.

The present disclosure has a computer system 600 as shown in FIG. 6, which may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server or a tablet computer system.

According to an embodiment, the computer system 600 comprises of a mobile computing device such as smartphone, a mobile telephone, a tablet or a laptop. The device includes a memory interface 620-1, one or more processing units 620-2 and a peripherals interface 620-3.

The peripherals interface 620-3 is coupled to various sensors and subsystems, including a camera subsystem 640, a wireless communication subsystem(s) 650, an audio subsystem 660, an I/O subsystem 630, etc. The peripherals interface 620-3 enables communication between the processing units and various peripherals.

The camera subsystem 640 is coupled to one or more optical sensors (e.g., a charged coupled device (CCD) optical sensor, a complementary metal-oxide-semiconductor (CMOS) optical sensor, etc.). The camera subsystem 640 coupled with the optical sensors facilitates camera functions, such as image and/or video data capturing. The camera subsystem 640 has a camera controller in communication with the central processor and the camera 114. The camera controller comprises circuitry configured to control recording of either photographic content or video content based on the input. The camera controller interacts with the memory to store, organize, and present image content in the form of photo content and video content.

The wireless communication subsystem 650 serves to facilitate communication functions. In some embodiments, the wireless communication subsystem 650 includes radio frequency receivers and transmitters, and optical receivers and transmitters. These receivers and transmitters of some embodiments are implemented to operate over one or more communication networks such as a GSM network, a Wi-Fi network, a Bluetooth network, etc.

The audio subsystem 660 is coupled to a speaker 116 to output audio. Additionally, the audio subsystem 660 is coupled to a microphone to facilitate voice-enabled functions, such as voice recognition (e.g., for searching), digital recording, etc.

The Input/output (I/O) subsystem 630 involves transfer between input/output peripheral devices, such as a display, a touch screen, etc., and the data bus of the processing units through the peripherals interface. The I/O subsystem 630 includes a touch-screen controller and other input controllers to facilitate the transfer between input/output peripheral devices and the data bus of the processing units.

The memory interface 620-1 is coupled to memory. The memory may be a volatile memory (e.g., high-speed random-access memory), non-volatile memory (e.g., flash memory), a combination of volatile and non-volatile memory, and/or any other type of memory. The mobile computing device also has storage capabilities in form of additional local storage. The local storage may in itself be another device or a drive or a partition or segment of the local memory.

Embodiments of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

We claim:

1. A system comprising:
a processor; and
memory coupled to the processor and storing instructions that, when executed by the processor, cause the system to perform operations comprising:
retrieving a digital content comprising any or a combination of image content and video content pertaining to an event from a digital storage medium and storing said retrieved digital content in a secured repository;
sharing an access code of the secured repository with a plurality of participants of the event in order to allow one or more participants of the plurality of participants to selectively access the secured repository;
responsive to receipt of a request through accessing the access code by at least one participant of the one or more participants, receiving an image of the at least one participant from a participant device and matching the received image with the digital content or part thereof to verify identity of the at least one participant; and
responsive to the verification of identity of the at least one participant, transmitting a part of the digital content to the participant device, wherein said part of the digital content pertains to the at least one participant.

2. The system of claim 1, wherein the at least one participant selects viewing of the part of the digital content transmitted to the at least one participant device, and wherein said viewing comprises viewing any or a combination of the part of the digital content pertaining only to the at least one participant and the part of the digital content pertaining to the at least one participant with the one or more participants in a group.

3. The system of claim 1, wherein the access code is shared in form of any or a combination of a uniform resource locator (URL), a bar code, a QR code and an alpha numeric code.

4. The system of claim 1, wherein the access code is shared via any or a combination of a text message, an email, a social media message and a multimedia message.

5. The system of claim 1, wherein the image of the at least one participant is real-time image captured using the camera on the participant device and uploaded by the participant onto the system for identity verification.

6. The system of claim 1, wherein the image of the at least one participant is selected from a plurality of images or videos stored in the participant device and uploaded by the participant onto the system for identity verification

7. The system of claim 1, wherein multiple participants can together share an image of all such multiple participants to retrieve all digital content where at least one part of each participant is present in the displayed digital content and then select to view all digital content where all such multiple participants are present together in each image of the displayed digital content.

8. The system of claim 1, wherein the system monitors the part of the digital content being viewed at the participant device.

9. The system of claim 7, wherein the system maintains a log of attributes of the participant who views the part of the digital content.

10. The system of claim 1, wherein the system receives a notification when the plurality of images and videos are received for storage in the secured repository and wherein the secured repository is controlled by an administrator using an administrator device.

11. A method comprising:
retrieving, by a computing device, a digital content comprising any or a combination of image content and video content pertaining to an event from a digital storage medium and storing said retrieved digital content in a secured repository;
sharing, by the computing device, an access code of the secured repository with a plurality of participants of the event in order to allow one or more participants of the plurality of participants to selectively access the secured repository;
responsive to receipt of a request through accessing the access code by at least one participant of the one or more participants, receiving, by the computing device, an image of the at least one participant from a participant device and matching the received image with the digital content or part thereof to verify identity of the at least one participant; and
responsive to verification of identity of the at least one participant, transmitting, by the computing device, a part of the digital content to the participant device, wherein said part of the digital content pertains to the at least one participant.

12. The method of claim 11, wherein the at least one participant selects viewing of the part of the digital content transmitted to the at least one participant device, and wherein said viewing comprises viewing any or a combination of the part of the digital content pertaining only to the at least one participant and the part of the digital content pertaining to the at least one participant with the one or more participants in a group.

13. The method of claim 11, wherein the access code is shared in form of any or a combination of a uniform resource locator (URL), a bar code, a QR code and an alpha numeric code.

14. The method of claim 11, wherein the access code is shared via any or a combination of a text message, an email, a social media message and a multimedia message.

15. The method of claim 11, wherein the image of the at least one participant is real-time image captured using the camera on the participant device and uploaded by the participant onto the system for identity verification.

16. The method of claim 11, wherein the image of the at least one participant is selected from a plurality of images or videos stored in the participant device and uploaded by the participant onto the system for identity verification.

17. The method of claim 11, wherein multiple participants can together share an image of all such multiple participants to retrieve all digital content where atleast one part of each participant is present in the displayed digital content and then select to view all digital content where all such multiple participants are present together in each image of the displayed digital content.

18. The method of claim 11, wherein the method comprises monitoring the part of the digital content being viewed at the participant device.

19. The method of claim 17, wherein the method comprises maintaining a log of attributes of the participant who views the part of the digital content.

20. The method of claim 11, wherein the method comprises receiving a notification when the plurality of images and videos are received for storage in the secured repository and wherein the secured repository is controlled by an administrator using an administrator device.
